(19) United States
(12) Patent Application Publication
(10) Pub. No.: US 2011/0036616 A1
(43) Pub. Date: Feb. 17, 2011

(54) POWER CABLE

(76) Inventors: Jonathan Catchpole, Oxfordshire (GB); Jonathan Mark Eyles, Wiltshire (GB); Robert Alexander Blanch, Whiltshire (GB); Stewart Topliss, Wiltshire (GB)

Correspondence Address: BAKER & DANIELS LLP, 300 NORTH MERIDIAN STREET, SUITE 2700, INDIANAPOLIS, IN, 46204, US

(21) Appl. No.: 12/989,057

(22) PCT Filed: Mar. 17, 2009
(86) PCT No.: PCT/GB2009/050255

§ 371 Date: Oct. 21, 2010

(30) Foreign Application Priority Data
Apr. 22, 2008 (GB) 0807298.5

(51) Int. Cl. H01B 7/00; H01B 5/00

(52) U.S. Cl. 174/119 R; 174/133 R

(57) ABSTRACT

A power cable (10), especially a jumper cable, comprising a self-supporting, fiber-reinforced polymer substrate (12) such as fiber glass coupled to a metal conductor (11).

### FIELD OF INVENTION

This invention relates to a power cable.

### SUMMARY OF INVENTION

In accordance with the present invention, there is provided a power cable comprising fiber-reinforced polymer substrate (such as fiber glass) coupled to a metal conductor, ideally, all encased in heat shrink tubing.

Such cable may be particularly effective when used as a jumper cable for interconnecting train carriages as such a cable may dynamically flex in three dimensions and rotate to accommodate movement between carriages in use, and yet remaining self-supporting, even when supporting very large conducting braids. For example, it is not uncommon for interconnects for train carriages to employ braids weighting up to 18 Kg (being configured to carry upwards of 2500 Amps).

### BRIEF DESCRIPTION OF DRAWINGS

The invention will now be described, by way of example only, with reference to the following figures in which:

FIG. 1 is a section through a jumper cable according to the present invention;

FIG. 2 is a 3-D view of the jumper cable of FIG. 1; and

FIG. 3 is a 3-D view of an alternative jumper cable according to the present invention.

### DETAILED DESCRIPTION

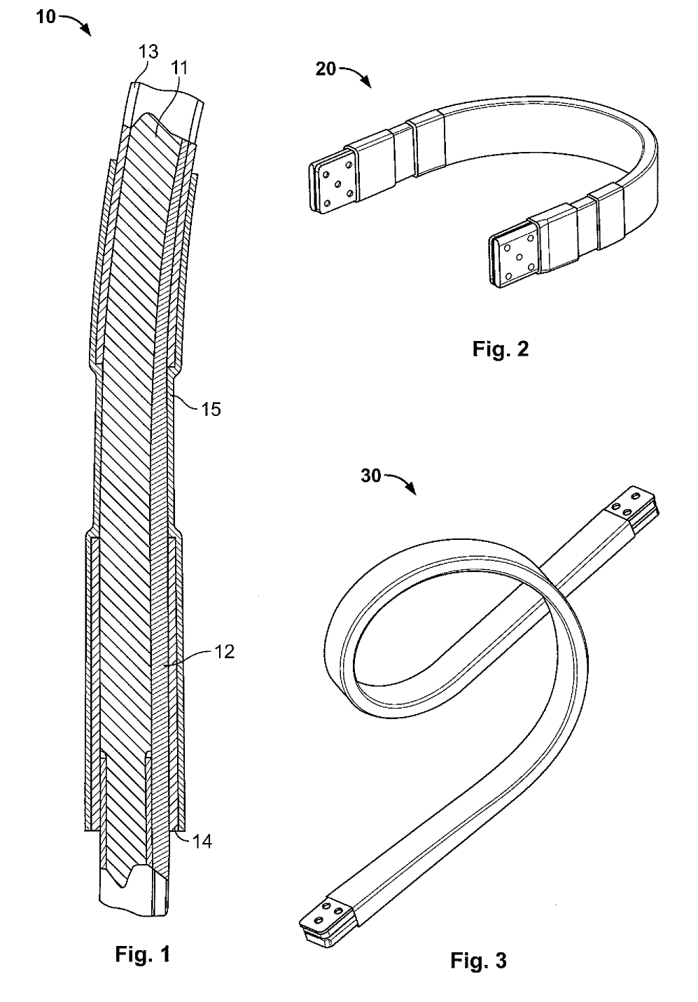

Referring to FIG. 1, a section through part of a jumper cable reveals a conducting, tin coated, copper braid 11 supported by a fiber glass substrate 12, all encased in heat shrink tubing 13, 15 with sealant 14 there between rendering the cable weatherproof. In use, the fibre glass substrate will support the weight of itself and of the braid which is particularly convenient in applications where such self-supporting is desirable, but where the braid itself would otherwise have insufficient rigidity to be self-supporting.

The fibre glass substrate 12 is tapered, thereby providing greater rigidity/support at the end where it is thickest and less rigidity/support where it is thinnest. Such a taper is particularly useful to provide more rigidity/support where a cable braid is crimped, and less where a cable is not so crimped (and has more internal rigidity).

Such a taper may also be useful for a self-supporting cable which is firmly anchored at one end, and thus requires more rigidity/support at that end which supports the entire cable's weight, compared to the free-standing end of the cable which does not.

FIG. 2 is a 3-D view of the jumper cable 10 of FIG. 1 and FIG. 3 is a 3-D view of an alternative jumper cable 30 according to the present invention. Other configurations are contemplated.

Fiber glass is proposed as a suitable fiber-reinforced polymer, withstanding relatively high temperatures, e.g. 80° C., and maintaining most of its mechanical strength.

1-6. (canceled)

7. A power cable comprising a self-supporting, fiber-reinforced polymer substrate coupled to a metal conductor.

8. A power cable according to claim 7, wherein the thickness of the fiber-reinforced polymer substrate is tapered along the length of the cable.

9. A power cable according to claim 8, wherein the thickness of the fiber-reinforced polymer substrate is thicker adjacent a portion of the cable that is crimped compared to that adjacent a portion of the cable that is not crimped.

10. A power cable according to claim 7, wherein the fiber-reinforced polymer is fiberglass.

11. A power cable according to claim 8, wherein the fiber-reinforced polymer is fiberglass.

12. A power cable according to claim 9, wherein the fiber-reinforced polymer is fiberglass.

13. A power cable according to claim 7, all encased in heat shrink tubing.

14. A power cable according to claim 8, all encased in heat shrink tubing.

15. A power cable according to claim 9, all encased in heat shrink tubing.

16. A power cable according to claim 7, wherein the cable is profiled as a jumper cable.

17. A power cable according to claim 8, wherein the cable is profiled as a jumper cable.

18. A power cable according to claim 9, wherein the cable is profiled as a jumper cable.
